(19) United States
(12) Patent Application Publication
(10) Pub. No.: US 2019/0381812 A1
(43) Pub. Date: Dec. 19, 2019

(54) MEDIA SHEET FINISHING

(71) Applicant: Hewlett-Packard Development Company, L.P., Houston, TX (US)

(72) Inventors: Robert Scott Beale, Vancouver, WA (US); Bruce G. Johnson, Vancouver, WA (US); Robert Yraceburu, Camas, WA (US); Bob Reichert, Vancouver, WA (US); Timothy Jacob Luedeman, Portland, OR (US)

(21) Appl. No.: 16/011,841

(22) Filed: Jun. 19, 2018

(51) Int. Cl. B41J 11/00; B41J 2/455; B41J 2/01

(52) U.S. Cl. CPC B41J 11/0015; B41J 2/01; B41J 2/455

(57) ABSTRACT

An example finishing device may include a monoclamp, a carrier body, and a biasing element located between the monoclamp and the carrier body to force the monoclamp away from the carrier body.

### BACKGROUND

Imaging systems, such as printers, copiers, etc., may be used to form markings on print media, text, images, etc. In some examples, imaging systems may form markings on the print medium by performing a print job. A print job can include forming markings such as text and/or images by transferring a print substance (e.g., ink, toner, etc.) to the print media. The print media may be stacked on a tray after printing. The printing device may be connected to a finishing device (e.g., a finisher) that may perform a finishing process on the stacked print media.

### BRIEF DESCRIPTION OF THE DRAWINGS

FIG. 1 illustrates an example finishing device including a biasing element, a monoclamp, and a carrier body.

FIG. 2 illustrates an example finishing device including a media transport device, an encoded motor system, and a bias member.

FIG. 3 illustrates an example finishing device including a media transport device, an attachment device, a push-pull member, and a bias member.

FIG. 4 illustrates an example system including a printing device and a finishing device.

### DETAILED DESCRIPTION

Printing devices can be utilized to form markings on a print media. As used herein, a printing device includes a hardware device that transfers a print substance on to a print media such as paper. For example, a printing device can include an inkjet printer that can deposit liquid or ink on to the print media to form a marking. As used herein, the term “print media” may include paper, photopolymers, plastics, composite, metal, wood, or the like. For example, a print media sheet may be deposited onto a finishing tray during a print job. A print media sheet may refer to a piece of print media (e.g., a sheet of paper) upon which markings may be formed to make up a physical representation of the output of a print job or a portion of an output of a print job. As used herein, the term “print job” refers to signals or states, which may be stored in a file and/or a set of files, usable to instruct a print device in forming text, images, and/or objects on print media. Among other things, the print job may include information relating to the print media. For example, a print job may include information such as an amount of print media sheets to be used in forming text, images, and/or objects on print media, a size or format (e.g., dimensions) of the printed media sheets, a paper type (e.g., paper weight, thickness, recycled content etc.), of the print media sheets, etc.

As used herein, the term “finishing tray” may refer to a component coupled to the printing device with a surface to collect the print media sheets as a print job progresses. The print media sheets may be aligned and/or arranged (e.g., registered) along an edge to form a stack on the finishing tray such that a finishing operation may be performed on a stack of print media sheets. As used herein, the term “stack” refers to a vertical pile of print media sheets. As should be apparent, a stack of print media sheets may increase in height as a print job progresses (e.g., as subsequent print media sheets are added to the stack). A post-processing action, referred to herein as “finishing,” may be performed on a stack of print media sheets corresponding to a print job. For example, a finishing operation may be performed on a stack of print media sheets, including stapling, hole-punching, folding, and/or collating, etc. A finishing operation may be performed on a print job by a finishing device (e.g., a finisher), which may be included in a printing device, included in the finishing tray, and/or external to the printing device. As used herein, the term “finishing device” refers to a mechanical and/or electrical component to perform finishing operations, in some examples, the finishing device may be a finisher or a portion of the printing device and/or the finishing tray.

Print media sheets are transferred from a print zone of a printer (e.g., a portion of a printer for applying a print substance to media, such as a printhead to apply liquid print substance to media) to the finishing tray by a media transport device. As used herein, the term “a media transport device” refers to an assembly of mechanical and/or electrical components to move print media to or within a finishing device (e.g., from a print mechanism such as a printing device).

When the print media sheet is moved by the media transport device to the finishing tray, the stack of print media may be misaligned for finishing operations. For instance, shingling can occur within the stack. As used herein, “shingling” includes a top sheet and an underlying stack being pushed away (e.g., from a P-reference) with each closing of a clamp of the finishing device. For instance, rotation of a monoclamp may occur during finishing. The rotation may occur in a theta-x direction with a y-direction component causing a current sheet and previously accumulated sheets to shift in a y-direction, resulting in a shingled stack. This shingling can result in an untidy and/or non-uniform stack, which may be undesirable for users, and/or it may jam or damage a printing device or finishing device.

Additionally, backlash can occur during the finishing process when clearances between mechanical parts of the finishing device create an overall clearance between the media transport device and an associated motor system. Backlash, as used herein, is a clearance or lost motion in a mechanism caused by gaps between parts. The backlash can result in positioning errors for stacks, which again can result in untidy and/or non-uniform stack, which may be undesirable for users, and/or it may jam or damage a printing device or finishing device.

Some finishing devices use shims to absorb clearances to eliminate shingling and theta-x rotation, but by removing the clearance, accommodations for reduced degrees of freedom introduced by some clamps may be lost. To address backlash, some finishing devices use tampers to push print media sideways to align it with other media in a stack. However, tampers introduce acoustic challenges when they tap the sides of media, and when used with certain printing devices such as laser printers, tampers or other components may be expensive and may increase power and energy usage.

A finishing device according to the present disclosure can include a spring between a monoclamp and a carrier body of the finishing device to force the monoclamp away from the carrier body to reduce or remove theta-x rotation of the monoclamp and reduce shingling of the stack. Additionally, a finishing device according to the present disclosure can reduce backlash at both a beginning position of an X-registration system and an ending position of an X-registration system by biasing a media transport device of the X-registration system using a bias member. The bias member can reduce clearances between mechanical parts of the finishing device, resulting in better-aligned printed media as compared to a finishing device without the bias member.

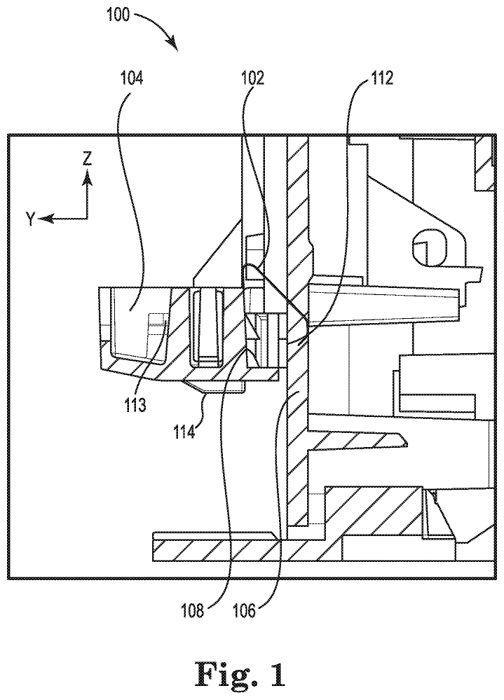

FIG. 1 illustrates an example finishing device 100 including a biasing element 102, a monoclamp 104, and a carrier body 106. As used herein, a monoclamp refers to a clamp having integral and distinct pads 114 to clamp a print medium. Finishing device 100, for instance, may use the monoclamp 104 for clamping of print media as it is delivered to a stacking region that collects a stack of print media.

In some examples, monoclamp 104 can be a gimbaled monoclamp. A gimbaled monoclamp may decrease the front/rear force ratio and/or eliminate a potential for mistiming, as compared to approaches employing two individual clamps. Specifically, a gimbaled monoclamp may include a monoclamp disposed partially in a housing and including a first pad 114 and a second pad (not shown) which extends through a first opening and a second opening of the housing. Additionally, the gimbaled monoclamp may include a pin extending through an opening in the clamp into a pivot point 113 to couple the clamp to the housing in a gimbaled manner. As used herein, being gimbaled and a gimbaled manner refer to a pivoted support that allows the rotation of an object about a single axis. Finishing device 100, in some examples may be included as a component of a printing device or finishing device 100 may be an external device separate from a printing device.

In some examples, biasing element 102 can be mounted in monoclamp 104, such that it rides a wall 108 of monoclamp 104 reducing rotation of monoclamp 104 (e.g., preventing monoclamp 104 from rotating). Biasing element 102, in some examples, can include a spring. Increased part clearances can increase theta-x rotation of the monoclamp as it is driven against a shelf (e.g., contact point). This rotation in theta-x can result in shingling. To control a clearance between monoclamp 104 and carrier body 106, (e.g., to reduce the additional clearance) biasing element 102 can be inserted between monoclamp 104 and carrier body 106. For instance, the biasing element 102 can reduce the theta-x rotation at a moment of clamping and reduce media stack shingling. Biasing element 102 can be mounted in monoclamp 104, in some examples, and can act against an exterior surface 112 of carrier body 106 forcing monoclamp 104 away from carrier body 106 and reducing contact and resultant wear. The force can be applied evenly throughout a range of motion of monoclamp 104, reducing theta-x motion of monoclamp 104 at an end of its travel which can reduce shingling. In some instances, racks mounted (e.g., rigidly) to monoclamp 104 can be pulled against their running surfaces on an interior of carrier body 106 when monoclamp 104 is forced away from carrier body 106 by biasing element 102. The pulling of the racks, in some examples, can reduce (e.g., prevent) theta-Y rotation of monoclamp 104 from gravity or clamping forces, among others.

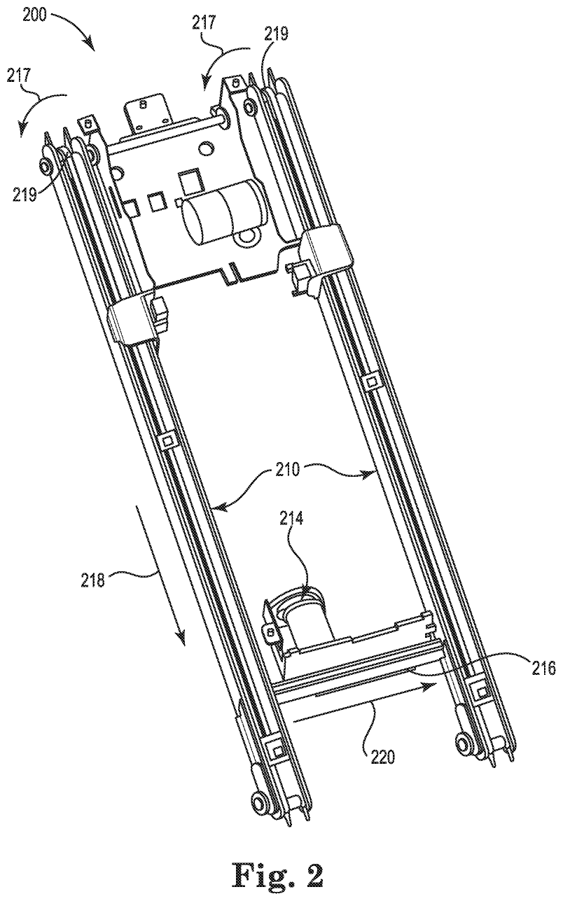

FIG. 2 illustrates an example finishing device 200 including a media transport device 210, an encoded motor system 214, and a bias member 216. Media transport device 210 can move print media sheets from a print mechanism to a finishing zone of finishing device 200. For reference, arrow 218 indicates y-direction of print media travel, while arrow 220 indicates x-direction of print media travel. Finishing device 200 can include an x-registration system, which refers to the use of x-coordinates (and the x-direction of travel) as a reference for print media sheets. An x-registration system, for instance, can include a push-pull member, gears, a rack, gear pins, an attachment device, and a motor pinion, among other components. An x-registration system can include a system for transporting a print media sheet that can translate the print media sheet in the x-direction and the y-direction. In some examples, an x-registration system can determine a distance a print media sheet is to be moved in an x-direction to align with previously accumulated print media sheets. In such an example, the print media sheet may be translated a distance in the x-direction greater than in the y-direction or vice versa.

Media transport device 210 can be connected to an integrated positional encoded motor system 214 through a series of mechanical parts including retainer clips, a push-pull member, gears, gear posts, and structural elements. Encoded motor system 214, in some examples, can control portions of finishing device 200. For instance, encoded motor system 214 can rotate media transport device 210 so media, such as print media sheets, moves in an x-direction. Rotation can occur in the direction of arrows 217 around pivot points 219, for instance. At each interface between the mechanical parts, there can be clearances of indeterminant sizes to account for part manufacturing variation. When these clearances are added together, they can create an overall clearance (“backlash”) of indeterminant size between media transport device 210 and encoded motor system 214. This backlash can be reduced by biasing media transport device 210 using bias member 216. Bias member 216 can apply enough force to overcome friction forces associated with media transport device 210 and its drive mechanism, but not enough force to negatively affect an actuator of the drive mechanism.

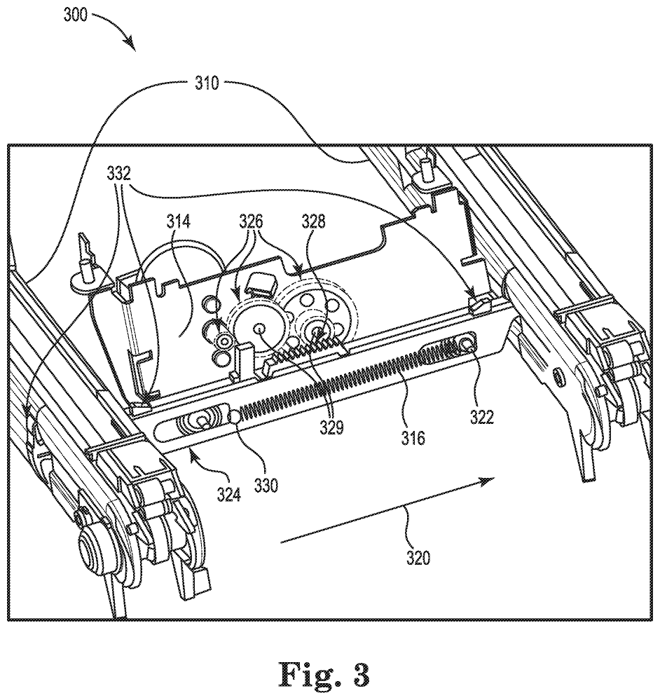

FIG. 3 illustrates an example finishing device 300 including a media transport device 310, an attachment device 322, a push-pull member 324, and a bias member 316. FIG. 3 illustrates a detailed view of portions of FIG. 2. Bias member 316, which in some examples can be an extension spring, can be hooked on one end to attachment device 322 attached to encoded motor system 314 and on an opposite end to push-pull member 324 via a hook feature 330 on push-pull member 324. Attachment device 322 can include, for instance, a hook, a hole, a screw, or other attachment device to which bias member 316 can be attached. Attachment device 322 can be a rigid, fixed attachment device in some examples. Bias member 316 can create biasing forces between push-pull member 324, gears 326, rack 328, gear pins 329, and a motor pinion that reduce (e.g., eliminate) clearances between these mechanical components.

With the reduction in clearances, an encoder on encoded motor system 314 can more accurately represent the media transport device 310 in the x-registration direction 320 both when an edge of a media sheet is detected by a sensor, and when the x-registration system has moved to a final page alignment position. This can result in better aligned printed pages of media in finishing device 300 through improved accuracy of sheet-to-sheet registration for stacking print media in finishing device 300 as compared to finishing devices without reduced backlash.

In some examples, one end of bias member 316 can be attached to media transport device 310 rather than push-pull member 324. In such an example, this can reduce (e.g., eliminate) clearances between clips 332, media transport device 310, and push-pull member 324. Reduced backlash, in some examples, can also enable less expensive methods (e.g., a biasing element may be less expensive than an actuated subsystem) and lower energy methods of post-processing inkjet printed media. For instance, inkjet printing can use lower energy as compared to laser printing, and laser tappers don't work well with inkjet printed media. For example, it may be difficult to tap damp inkjet media into place because inkjet media may stick together and/or buckle rather than slide. In some instances, quieter methods of x-registering sheets of media in finishing device 310 can also be a result of reduced backlash. For instance, noisy tappers may be avoided.

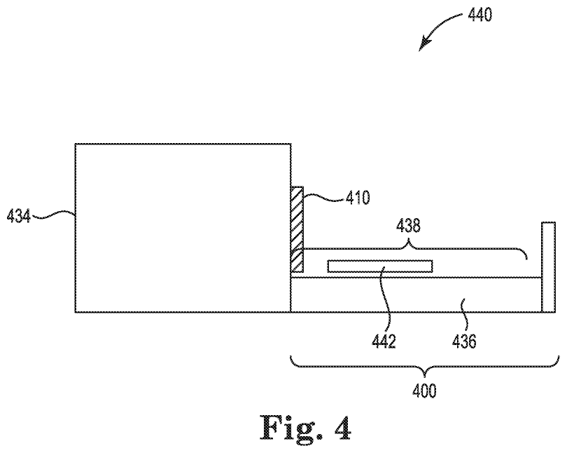

FIG. 4 illustrates an example system 440 including a printing device 434 and a finishing device 400. Printing device 434 can include, for instance an inkjet printing device or a laser printing device, among others. System 440 can include a media transport device 410 analogous to media transport devices 210 and 310 illustrated in FIGS. 1, 2, and 3. For instance, media transport device 410 can include an x-registration media transport device to move a print media sheet 442 from printing device 434 to a finishing zone 438 and align print media sheets in the x-direction.

Although not shown in FIG. 4 for clarity and so as not to obscure examples of the disclosure, print media sheet 442 may include a plurality of print media sheets 442. For example, the print media sheet 442 may be a stack including a plurality of print media sheets 442. As used herein, the print media sheet 442 may be collectively referred to as the print media sheet 442 (e.g., singular), the print media sheets 442 (e.g., plural), and/or the stack of print media sheets 442. The printing device may move an individual print media sheet 442 to a stack on a finishing tray 436.

Media transport device 410 can move the print media sheets 442 from printing device 434 in a positive y-direction and a positive x-direction to a finishing zone 438, and the print media sheets 442 may form a stack of print media sheets 442. As used herein, the term “finishing zone” refers to an area on the finishing tray 436 where the media transport device 410 may move the print media sheets 442 before, during, or after finishing. In some instance, the finishing zone 438 may include a finishing device 400 to perform finishing operations on the print media sheets 442. Put another way, finishing device 400 may be a finisher for post-printing actions (e.g., stapling, hole-punching, folding, or collating).

Finishing device 400, in some examples, can include a biasing element located between a monoclamp and a carrier body (e.g., as illustrated in FIG. 1) to force the monoclamp away from the carrier body and increase clearance between the monoclamp and the carrier body. The biasing element, in some instances, can be mounted in the monoclamp, act against an exterior of the carrier body, and hold the monoclamp in a particular orientation. For instance, by keeping the monoclamp in a particular orientation, theta-x rotation is reduced.

In some examples, when a gimbaled monoclamp is used, two independent racks can be driven by a single shaft. Degrees of freedom of the two-independent-racks system can be reduced because the monoclamp spans and connects both racks. Clearance between a monoclamp and a carrier body can be increased to reducing system binding issues. The increased clearance can result in theta-x rotation of the monoclamp while clamping and in turn, media stack shingling. The spring can be used to force the monoclamp away from the carrier body by applying a force to the monoclamp evenly throughout a range of motion of the monoclamp. In addition to reducing theta-x rotation and shingling, use of the biasing element can allow parts to be built with tolerances desired for multi-cavity injection molds (e.g., allowing assembly without binding) while orientating assembled parts such that clearances can be controlled and extraneous motion (e.g., theta-x rotation) and unwanted side effects can be reduced.

In some examples, media transport device 410 can have coupled to it a rigid attachment device and a bias member (e.g., as illustrated in FIG. 3). The bias member can be also coupled to the attachment device, and can bias the attachment device, media transport device 410, and a push-pull member to reduce clearances between the attachment device, the push-pull member, and media transport device 410. In some instances, the bias member is an extension spring to remove a motion of x-registration media transport device 410 For instance, a print media sheet 442 can be pulled from left to right (e.g., from the perspective of a user standing in front of the printing device 434). This motion is perpendicular to the motion that the bias member removes. The print media sheet 442 can also be moved from front to rear (again from the perspective of a user standing in front of the printing device 434). This motion is parallel to the motion removed by bias the bias member.

In some examples, system 440 can include a controller (not pictured). As used herein, the term “controller” refers to a computing device that may contain a processing resource and a memory resource to execute instructions. The controller may be included in the printing device 434, finishing device 400, a standalone device, or in a separate device that may be located external to system 440. The controller may determine information relating to the print job or finishing job and execute instructions based on that information. For instance, the controller may actuate portions of finishing device 400, such as a monoclamp.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. Similar elements or components between different figures may be identified by the use of similar digits. For example, 216 may reference element “16” in FIG. 2, and a similar element may be referenced as 316 in FIG. 3.

Elements illustrated in the various figures herein can be added, exchanged, and/or eliminated so as to provide a plurality of additional examples of the disclosure. In addition, the proportion and the relative scale of the elements provided in the figures are intended to illustrate the examples of the disclosure and should not be taken in a limiting sense. As used herein, the designator “N”, particularly with respect to reference numerals in the drawings, indicates that a plurality of the particular feature so designated can be included with examples of the disclosure. The designators can represent the same or different numbers of the particular features. Further, as used herein, “a plurality of” an element and/or feature refers to more than one of such elements and/or features.

The above specification, examples and data provide a description of the method and applications and use of the system and method of the present disclosure. Since many examples can be made without departing from the spirit and scope of the system and method of the present disclosure, this specification merely sets forth some of the many possible example configurations and implementations.

1. A finishing device, comprising:
a monoclamp;
a carrier body; and
a biasing element located between the monoclamp and the carrier body to force the monoclamp away from the carrier body.

2. The finishing device of claim 1, wherein the monoclamp is a gimbaled monoclamp.

3. The finishing device of claim 1, wherein the biasing element is further to pull racks mounted to the monoclamp against running surfaces on an interior of the carrier body.

4. The finishing device of claim 1, wherein the biasing element is further to reduce theta-x rotation of the monoclamp as it is driven against a shelf of the finishing device.

5. The finishing device of claim 1, wherein the biasing element is further to control a clearance between the monoclamp and the carrier body.

6. The finishing device of claim 1, wherein the biasing element is mounted in the monoclamp.

7. The finishing device of claim 1, wherein the biasing element is to force the monoclamp away from the carrier body by applying a force to the monoclamp evenly throughout a range of motion of the monoclamp.

8. A finishing device, comprising:
a media transport device to move print media sheets from a print mechanism to a finishing zone of the finishing device;
an attachment device coupled to the media transport device;
a push-pull member coupled to the media transport device; and
a bias member coupled to the attachment device and the push-pull member to bias the attachment device and the push-pull member to reduce clearances between the attachment device, the push-pull member, and the media transport device.

9. The finishing device of claim 8, wherein the bias member is an extension spring.

10. The finishing device of claim 8, further comprising a rack, wherein the bias member is further to bias the attachment device, the push-pull member, and the rack to reduce clearances between the attachment device, the push-pull member, and the rack.

11. The finishing device of claim 8, further comprising gears, wherein the bias member is further to bias the attachment device, the push-pull member, and the gears to reduce clearances between the attachment device, the push-pull member, and the gears.

12. The finishing device of claim 8, further comprising a gear pin, wherein the bias member is further to bias the attachment device, the push-pull member, and the gear pin to reduce clearances between the attachment device, the push-pull member, and the gear pin.

13. The finishing device of claim 8, further comprising a rack, and a motor pinion, wherein the bias member is further to bias the attachment device, the push-pull member, and the motor pinion to reduce clearances between the attachment device, the push-pull member, and the motor pinion.

14. The finishing device of claim 8, further comprising an encoded motor system to control a portion of the finishing device.

15. A system, comprising:
a printing device; and
a finishing device coupled to the printing device comprising:
an x-registration media transport device to move print media sheets from the printing device to a finishing zone, the media transport device comprising:
a rigid attachment device coupled to the media transport device; and
a bias member coupled to the attachment device and the media transport device to bias the attachment device, the media transport device, and a push-pull member to reduce clearances between the attachment device, the push-pull member, and the media transport device; and
a biasing element located between a monoclamp and a carrier body to force the monoclamp away from the carrier body and increase clearance between the monoclamp and the carrier body.

16. The system of claim 15, wherein the bias member includes an extension spring to remove a motion of the x-registration media transport device.

17. The system of claim 15, wherein the biasing element located between the monoclamp and the carrier body holds the monoclamp in a particular orientation.

18. The system of claim 15, wherein the biasing element located between the monoclamp and the carrier body is mounted in the monoclamp and acts against an exterior of the carrier body.

19. The system of claim 15, wherein the printing device is an inkjet printing device.

20. The system of claim 15, wherein the printing device is a laser printing device.
